(19) United States
(12) Patent Application Publication
(10) Pub. No.: US 2008/0187819 A1
(43) Pub. Date: Aug. 7, 2008

(54) Sulfur fueled electro chemical cell

(76) Inventor: Wesley Martin Lang, Kaysville, UT (US)

Correspondence Address: WESLEY M. LANG, P.O. BOX 1909, SANDY, UT, 84091, US

(21) Appl. No.: 11/982,164

(22) Filed: Oct. 31, 2007

Related U.S. Application Data
(60) Provisional application No. 60/885,642, filed on Jan. 19, 2007.
(60) Provisional application No. 60/899,270, filed on Feb. 1, 2007.

(51) Int. Cl. H01M 4/00; C25B 9/00; C01B 17/00; H01B 1/06

(52) U.S. Cl. 429/50; 429/122; 429/232; 423/567.1; 252/500; 252/502; 204/242

(57) ABSTRACT

A method and apparatus is disclosed for utilizing sulfur as a consumable fuel in an electrochemical cell. The principal of the above described invention is that sulfur is oxidized or acts as an oxidizing agent to produce energy while avoiding the production of harmful gases and other byproducts, traditionally associated with the burning of sulfur.

### CROSS-REFERENCE TO RELATED APPLICATIONS

This application claims the benefit of U.S. Provisional Application No. 60/885,642 filed Oct. 31, 2006 in the United States Patent and Trademark Office and U.S. Provisional Application No. 60/899,270 filed Feb. 1, 2007 in the United States Patent and Trademark Office, which are hereby incorporated by reference herein in their entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

This disclosure relates generally to the use of sulfur as a consumable fuel in an electrochemical cell. More particularly, this invention produces energy by oxidizing sulfur in the presence of a liquid electrolyte. In the alternative, this invention can be configured to produce energy by using sulfur as the oxidizing agent to oxidize a metal in the presence of a liquid electrolyte. Thus, this invention allows sulfur to be utilized as a consumable fuel while avoiding the harmful gaseous by-products associated with burning sulfur.

2. Description of Related Art

The search for an effective utilization of energy sources has been of critical importance to civilization since the beginning of the industrial age. At the present time, most usable energy comes from the following principal sources: solar, in the form of photovoltaic cells and in growing vegetable and other organic matter that is either burned by humans or consumed by living organisms as a primary energy source; nuclear, in which the heat of a controlled nuclear fission reaction is used to generate electricity; and, the burning or “oxidation” of hydrocarbons contained in fossil fuels such as coal and oil. (wind and hydroelectric can also be considered a subcategory of the solar group in that it is the heat produced by solar radiation on the earth's surface that supplies the energy to drive these processes).

Of these sources, the burning of fossil fuels is by far the most significant to industrialized societies in terms of the percentage of energy produced and consumed. However, the burning of fossil fuels as the primary energy source for modern civilization possesses severe limitations that include the following. First, the supply of fossil fuels is finite. Thus, as a theoretical matter, fossil fuels will eventually become depleted. Second, the burning of fossil fuels produces deleterious byproducts including carbon dioxide. For example, because carbon dioxide in the atmosphere can theoretically slow the radiation of heat from the earth's surface, it is thought that an increased level of carbon dioxide in the atmosphere can result in an increase in the mean temperature of the earth's surface and surrounding atmosphere. Finally, fossil fuels are not distributed evenly throughout the earth's surface. This uneven distribution of an essential resource is associated with certain social and political dislocations observed in the world today.

Thus, it would be helpful to industrialized society to discover and utilize an additional energy source, currently existing on earth that can be utilized in place of, or in addition to, the existing energy sources in use today. Most of the elements contained at or below the earth's surface are not suitable as energy sources. Energy is most readily extracted from an atom or molecule by oxidizing it—usually in the form of burning. As used herein, burning refers to the combination with oxygen in the atmosphere to produce heat. When a molecule is burned, some, or all of its atoms combine with oxygen and, in the process release some of the potential energy contained within the electron bonds of the molecule in the form of heat.

The problem in finding a new fuel source to replace or supplement hydrocarbons is that most of the elements capable of being oxidized are already in an oxidized state due to their exposure to oxygen in the atmosphere. Hence, elements such as silicon, aluminum, zinc and iron, although plentiful at or near the earth's surface, already exist primarily in an oxidized state. Because they are already in and oxidized they are not usable as consumable fuels in any type of oxidation/reduction reaction. As used herein, a consumable fuel is defined as and element or compound as to which the following two conditions apply:
1. The element or compound that yields more energy in an oxidation/reduction reaction than was required to put the element or compound in a state suitable for participating in the oxidation/reduction reaction; and,
2. once the element or compound is utilized in an oxidation reduction reaction, it is not recovered, but rather is discarded.
   For the purposes of this disclosure, any element or compound which is being used in a manner consistent with these two conditions is being used as a consumable fuel. By way of example, hydrocarbons qualify as consumable fuels under this definition. In their natural state, or with minimal refining, hydrocarbons can take part in oxidation/reduction reactions that yield more energy than was required to put the hydrocarbon in a state suitable for participating in the oxidation/reduction reaction. As a consequence, hydrocarbons are utilized in oxidation/reduction reactions, and the products of these reaction, principally water and carbon dioxide, are generally not recovered but are discarded into the environment.

In contrast, elements such as silicon aluminum, zinc and iron, although plentiful at or near the earth's surface, already exist primarily in an oxidized state. Therefore, these elements must be refined in order to put them in a state suitable for participating in an oxidation/reduction reaction. And, the energy necessary to refine these elements is at least as great as or greater than the energy released in their oxidation/reduction reactions. Therefore, while these elements can serve as energy storage media in their refined states, they do not represent consumable fuels as that term is used in this disclosure.

Of all the oxidizable elements present in large quantities at or near the earth's surface, sulfur is the only one that exists in relatively large quantities in an unoxidized state. In addition, according to present day geological theory, sulfur is constantly being produced in an unoxidized or “reduced” state by the volcanic activity within the earth. Sulfur is a major product of volcanic eruptions, and is constantly being pumped to the surface through volcanic structures such as volcanic heat vents on the ocean floor. Large deposits of sulfur are also produced by bacterial action where they remain in an unoxidized form. Sulfur also occurs in varying quantities in conjunction with various hydrocarbons such as crude oil and coal. Sulfur dioxide emissions associated with the burning of sulfur containing coal and oils and gas has resulted in mandated removal of sulfur either prior to the burning of the hydrocarbon or after burning via scrubbing of the emissions. Government mandated sulfur removal from fuels has created a glut of sulfur that is presenting increasing disposal problems for oil and gas refiners. This problem will probably become exacerbated as refiners rely more and more on high sulfur content crude oil as supplies of lower sulfur crude oil become depleted. Finally, Sulfur occurs in very large quantities in oil shale regions of the world. For example, it is estimated that the Colorado Plateau region contains approximately 600 billion tons of sulfur. Assuming this sulfur can be economically extracted, it would provide a tremendous source of zero emission energy. Because of these characteristics, sulfur fits the definition of a consumable fuel as defined herein.

It is well known that sulfur can be readily burned and is thus readily oxidizable in an exothermic reaction. The potential energy it possesses makes it a theoretical source of consumable fuel. The drawback to utilizing sulfur as a consumable fuel in this manner is that the by-products of burning sulfur in the atmosphere are extremely toxic. Burning sulfur produces sulfur dioxide and sulfur trioxide gas, both of which are toxic. When these gases react with water, they produce sulfuric acid, the principal component of acid rain. Because of the harmful byproducts of burning sulfur, it has never qualified as a useful energy source, despite the potential energy it possesses. Thus, it would be desirable to develop a way to release the potential energy in sulfur by oxidizing it without producing the harmful by-products associated with burning it in the atmosphere. Thus, the current invention teaches using sulfur as a consumable fuel by harvesting its energy in an electrochemical oxidation/reduction reaction.

### SUMMARY

The current disclosure teaches an effective way to utilize sulfur as a consumable fuel in an electrochemical cell.

### BRIEF DESCRIPTION OF THE DRAWINGS

The features and advantages of the disclosure will become apparent from a consideration of the subsequent detailed description presented in connection with the accompanying drawings in which:

FIG. 1 is an apparatus capable of carrying out a storage battery type oxidation/reduction reaction.

FIG. 2 is an apparatus capable of carrying out a hydrogen fuel cell oxidation/reduction reaction.

FIG. 3 is a perspective view of the apparatus comprising an electrochemical cell that utilizes sulfur as a consumable in conjunction with oxygen.

FIG. 4 is a cross section of one embodiment of a sulfur electrode.

FIG. 5 is a perspective view an embodiment of a sulfur electrode.

FIG. 6 is a cross section view of an electrochemical cell that utilizes sulfur as a consumable fuel in an oxidation/reduction reaction with aluminum.

FIG. 7 is an apparatus that utilizes sulfur as a consumable fuel to produce hydrogen.

### DETAILED DESCRIPTION

At the outset, it should be appreciated that like drawing numbers on different views identify identical structure elements of the disclosure. While the present disclosure is described with respect to what is presently considered to be exemplary embodiments, it is understood that the disclosure is not limited to the disclosed embodiments.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure, which is limited only by the appended claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the preferred methods, devices, and materials are now described.

As used herein, a consumable fuel is defined as an element or compound as to which the following two conditions apply:
1. The element or compound that yields more energy in an oxidation/reduction reaction than was required to put the element or compound in a state suitable for participating in the oxidation/reduction reaction; and,
2. once the element or compound is utilized in an oxidation reduction reaction, it is not recovered, but rather is discarded.
   For the purposes of this disclosure, any element or compound which is being used in a manner consistent with these two conditions is being used as a consumable fuel. By way of example, hydrocarbons qualify as consumable fuels under this definition. In their natural state, or with minimal refining, hydrocarbons can take part in oxidation/reduction reactions that yield more energy than was required to put the hydrocarbon in a state suitable for participating in the oxidation/reduction reaction. As a consequence, hydrocarbons are utilized in oxidation/reduction reactions, and the products of these reaction, principally water and carbon dioxide, are generally not recovered but are discarded into the environment.

One alternative to burning a fuel in the atmosphere is to oxidize the fuel in an electrochemical cell. It is a well known phenomenon that electrical energy can be produced by the chemical reaction that takes place when a reducing element is combined with an oxidizing element in an oxidation/reduction reaction in an electrochemical cell. Whereas the byproduct of atmospheric oxidation/reductions is heat energy, the byproduct of an electrochemical oxidation/reduction reaction is electric current.

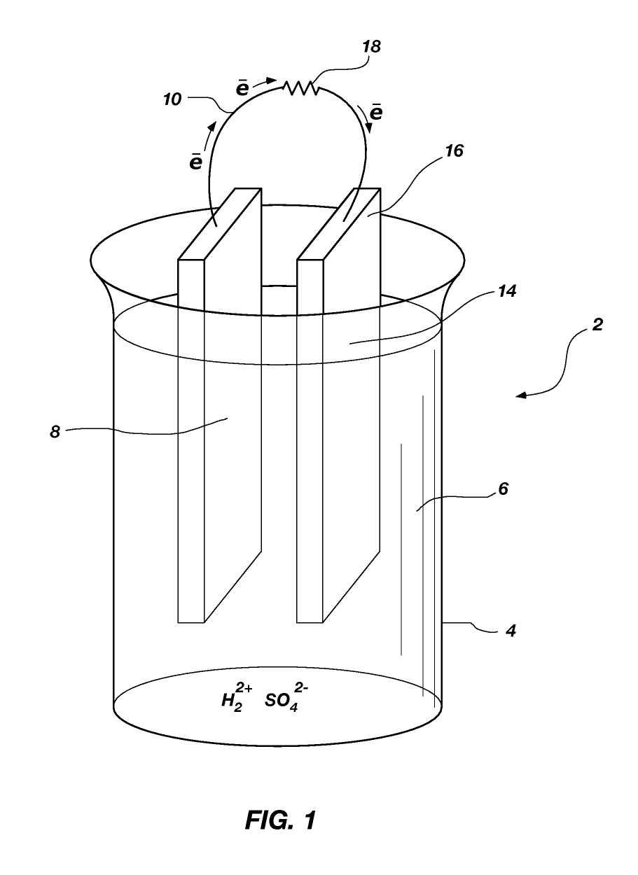

There are a wide variety of electrochemical cells known in the art. Some of the more common electrochemical cells include what are commonly called storage batteries. Batteries of the Lead/acid, zinc/copper and sodium/sulfur type are some of the more commonly known types of storage batteries. FIG. 1 is an illustration of an apparatus 2 capable of carrying out an electrochemical reaction of the type that takes place within the average storage battery.

In the apparatus 2 of FIG. 1, a container 4 contains a liquid electrolyte solution 6. In this case, the liquid electrolyte solution is sulfuric acid having a chemical formula of H2²⁺ SO4²⁻ dissolved in water. The apparatus 2 has a first electrode 8 comprised of Lead. This first electrode 8 is immersed in the electrolyte solution 6. The first electrode 8 has an electron conductor 10 whose first end 11 is attached to the first electrode's 8 upper end 12. This electron conductor 10 is made of a material that conducts electricity and thus allows the first electrode 8 to be in electrical contact with a second electrode 14 when the second end 16 of the electron conductor 10 is attached to the second electrode 14. In this instance, the second electrode 14 is comprised of lead oxide. The second electrode 14 is also immersed in the electrolyte solution 6. The first electrode 8 reacts with the SO4²⁻ ions to form PbSO4+2e−. The electrons produced by this reaction travel through the electron conductor 10 to the second electrode 14 where the following reaction takes place PbO2+4H⁺+SO4²⁻+2e⁻− [symbol] PBSO4+H2O. The energy of this reaction drives the electrons that are produce through the electron conductor 10 with a force that allows the electrons to do work on the resistor 18 located at a point along the electron conductor.

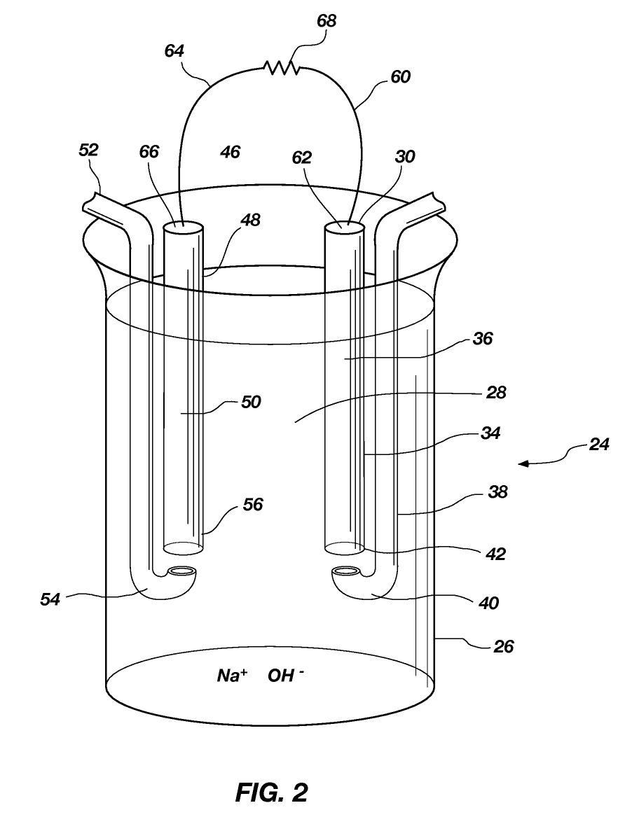

A defining characteristic of Storage batteries of the type depicted in FIG. 2 is that their energy is stored in their electrodes and/or electrolyte. The materials from which they derive their energy output like lead, originally existed in an oxidized form. Thus, in order to be put into a condition where they could participate in an oxidation/reduction reaction, they had to be refined in a process that requires at least as much energy as they produce in an oxidation/reduction reaction. Once the energy the electrodes store is depleted via the oxidation/reduction reaction that takes place within the storage battery, the storage battery must be either recharged, by introducing sufficient electrical energy to reverse the oxidation/reduction reaction, or thrown away, depending on whether the battery is rechargeable or not. In either case, storage batteries, do not utilize consumable fuel as that term is defined herein. Thus, a storage battery is not an energy source. It is merely an energy storage medium, with the energy that is stored generally coming from nuclear, fossil fuel or hydroelectric driven power plants.

Another type of electrochemical cell is known as the fuel cell. In a fuel cell, the electrical energy is continually produced by constantly introducing a fuel into the system. The fuel reacts in the presence of an electrolyte in an oxidation/reduction reaction to produce an electric current.

The most common fuel cell is the hydrogen fuel cell. FIG. 2 is a depiction of an apparatus 24 capable of carrying out a hydrogen/oxygen fuel cell reaction. In this apparatus 24, a container 26 contains a liquid electrolyte solution 28. In this case, the liquid electrolyte solution 28 is sodium hydroxide having a chemical formula of Na⁺ OH⁻ dissolved in water. The apparatus 24 has a first electrode 30 comprised of a cylindrical tube 34, open at both ends and containing stainless steel fibers 36 in its interior. The first electrode 30 is immersed in the electrolyte solution 28 such that the stainless steel fibers 36 are immersed in the electrolyte solution 28. A hollow tube 38 extends into the electrolyte solution 28 such that its first end 40 extends into the bottom opening 42 of the cylindrical tube 34. A second end (not shown) of the hollow tube 38 is attached to an oxygen source (not shown) such that the hollow tube 38 channels oxygen from the oxygen source (not shown) into the bottom opening 42 of the cylindrical tube 34. The oxygen, upon being released into the bottom opening 42 of the cylindrical tube 34 bubbles up through the electrolyte solution 28, past the stainless steel fiber 36, such that the oxygen molecules make intermittent contact with the stainless steel fiber 36.

The apparatus 24 has a second electrode 46 comprising a cylindrical tube 48, open at both ends and containing platinum fibers 50 in its interior. The second electrode 46 is immersed in the electrolyte solution 28 such that the platinum fibers 50 are immersed in the electrolyte solution 28. A hollow tube 52 extends into the electrolyte solution 28 such that its first end 54 extends into the bottom opening 56 of the cylindrical tube 48. A second end (not shown) of the hollow tube 52 is attached to a hydrogen source (not shown) such that the hollow tube 52 channels hydrogen from the hydrogen source (not shown) into the bottom opening 56 of the cylindrical tube 48. The hydrogen, upon being released into the bottom opening 56 of the cylindrical tube 48 bubbles up through the electrolyte solution 28, past the platinum fibers 50, such that the hydrogen molecules make intermittent contact with the platinum fibers 50.

The first electrode 30 has an electron conductor 60 inserted through the top opening 62 of the cylindrical tube 34 such that the electron conductor 60 makes electrical contact with the stainless steel fiber 36. This electron conductor 60 is made of a material that conducts electricity. A second electron conductor 64 is inserted through the top opening 66 of the cylindrical tube 46 such that the second electron conductor 64 makes electrical contact with the platinum fibers 50. Both the first electron conductor 60 and the second electron conductor 64 are in electrical contact with a resistor 68.

As oxygen is introduced into the first electrode 30 it reacts with the electrolyte solution 28 as it contacts the stainless steel fibers 36 according to the following reaction: O2+2H2O+4e−− [symbol] 4OH⁻. The OH⁻ ions produced by this reaction travel through the electrolyte solution 28 to react with the hydrogen where it contacts the platinum fibers 50 according to the following reaction 2OH+H2 [symbol] 2H2O+2e⁻. The electrons generated by this reaction travel through the second electron conductor 64 where they do work on a resistor 68. The electrons then travel through the first electron conductor 60 to the first electrode 30 where they participate in the reaction whereby the oxygen goes into reaction whereby the oxygen goes into solution as OH⁻.

Unlike storage batteries, fuel cells do not need to be recharged. A fuel cell is “recharged” by reloading it with fuel. In the apparatus of FIG. 2, the fuel is hydrogen. However, hydrogen does not represent a consumable fuel in every instance. Where the hydrogen is derived from a hydrocarbon such as methane, it can constitute a consumable fuel to the extent the energy required to separate the hydrogen from the carbon in the methane molecule is less than the energy produced in the fuel cell reaction. However, where the hydrogen is derived from water, the energy required to liberate the hydrogen from the water is greater than the energy obtained in the reaction. Therefore, hydrogen derived from water does not constitute a consumable fuel. A fuel cell that utilizes a hydrocarbon as a fuel is an example of an electrochemical reaction that utilizes a consumable fuel.

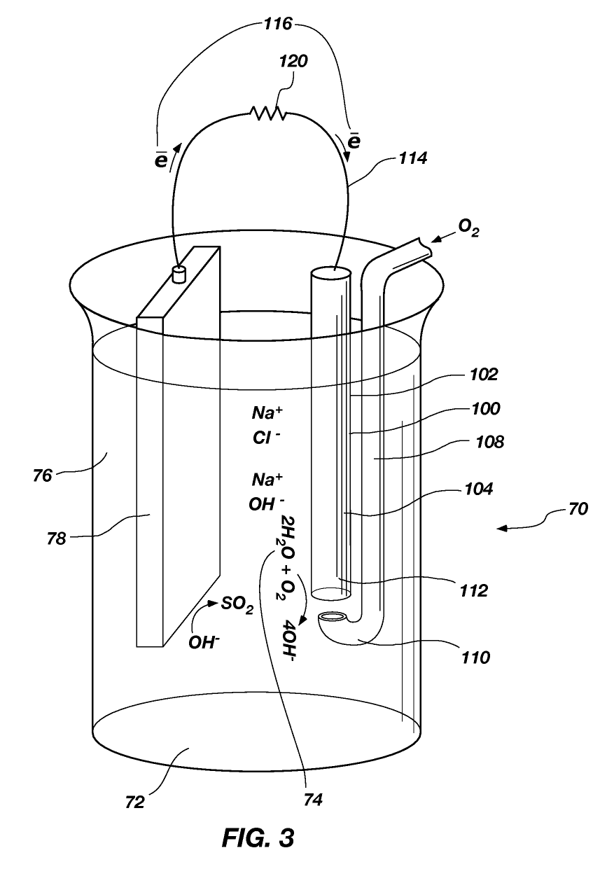

FIG. 3, is an illustration of an apparatus that utilizes sulfur as a consumable fuel in an electrochemical reaction. FIG. 3, depicts an electrochemical cell 70 comprising a container 72 capable of holding an electrolyte solution 74. This compartment can be constructed of glass, plastic, fiberglass, rubber, or any other material that will generally not react with the electrolyte solution 74. The container 72 may also be constructed initially of one or more materials that will generally react with the electrolyte solution 74 so long as the inner surface 76 of the container 72 is lined with a non reactive material. The electrolyte solution 74 can be any ph between 0 and 14. In the embodiment depicted in FIG. 3, the electrolyte solution 74 comprises a combination of Na+ OH− and Na+ Cl− dissolved in H2O. Suspended in the electrolyte solution 74 is a first electrode 78. This first electrode 78 is comprised of elemental sulfur impregnated with one or more other elements or compounds capable of conducting electricity.

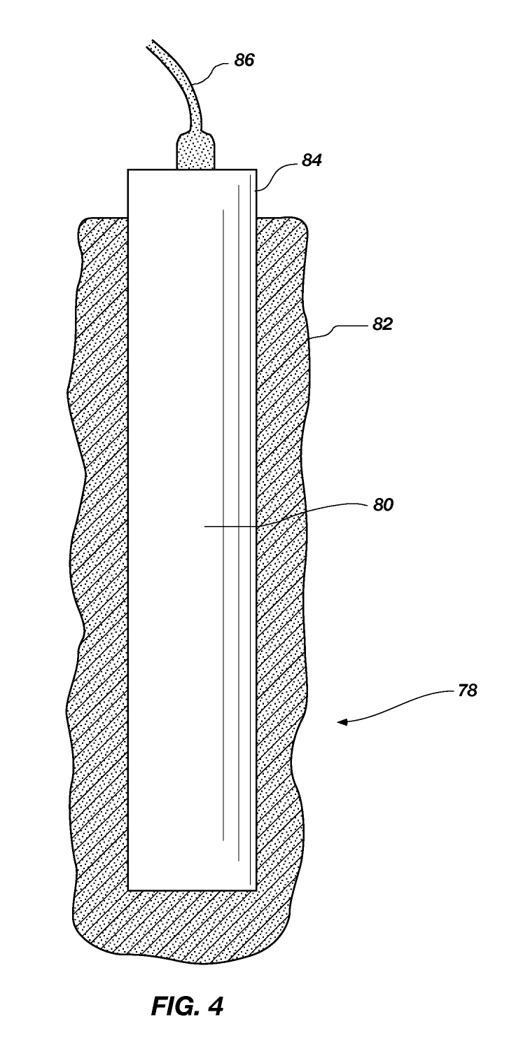

FIG. 4 depicts a cross section view of one embodiment of the first electrode 78. In this embodiment, the first electrode 78 comprises a core of stainless steel 80. The core of stainless steel 80 is coated with a mixture comprising elemental sulfur mixed with powdered graphite 82. Such electrode 78 can be made, among other ways, by melting sulfur and mixing in powdered graphite. The stainless steel core 80 is then dipped into the molten sulfur graphite mixture 82 and then allowed to cool. The sulfur graphite mixture 82 hardens as it cools in the form of a shell of solid sulfur graphite mixture around the stainless steel core 80. A length of exposed stainless steel 84 exists at one end of the electrode 78 to which is attached a conductor 86. The core can also be comprised of aluminum steel, iron, copper, zinc, carbon, carbon compound, metal alloy or any metal or other material capable of conducting electricity. While the embodiment depicted in FIG. 4 utilizes stainless steel, the core can be copper, zinc, aluminum, carbon or carbon nano tubes or any other metal, alloy or material capable of conducting electricity. The electrode can also consist solely of a mixture of graphite and sulfur with no metal or other core.

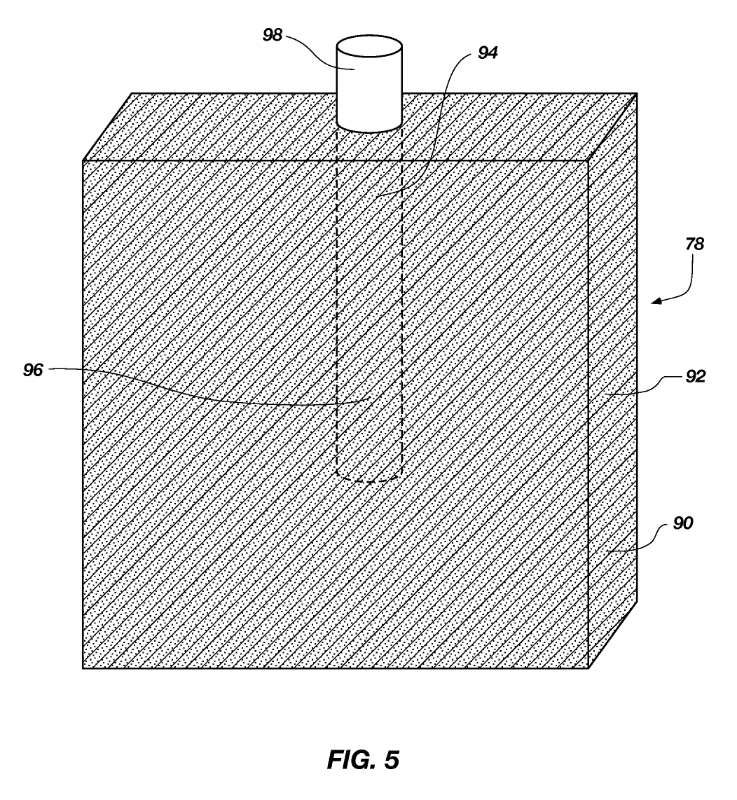

FIG. 5 depicts yet another alternative embodiment of the sulfur electrode 78 in which the sulfur electrode 78 is comprised of sulfur which is impregnated with very fine strands of an electron conducting material 90 such as steel, copper, aluminum, steel, zinc, carbon, carbon alloy, carbon nano tubes or any other material capable of both conducting electrons and being formed into thin filaments. Elemental sulfur 92 is located within the sulfur electrode 78 so as to fill all the spaces between the strands of electron conducting material 90. The sulfur electrode 78 depicted in this embodiment works best as the distance between the strands of electron conducting material 90 approach the width of two sulfur molecules. The sulfur electrode 78 also contains a post 94 that is situated such that a first end 96 is in contact with one or more of the strands of electron conducting material 90. The second end 98 of the post 94 extends beyond the sulfur electrode 78.

The strands of electron conducting material 90 are also situated so that each strand of electron conducting material 90 is in contact with at least one other strand of electron conducting material 90 such that each strand of electron conducting material 90 is ultimately in electrical contact with the post 94.

Returning now to FIG. 3, the apparatus 70 has a second electrode 100 comprised of a cylindrical tube 102, open at both ends and containing fibers 104 capable of conducting electrons in its interior. These fibers can be stainless steel, platinum, carbon, or any metal, alloy, compound or other material capable of conducting electricity. The second electrode 100 is immersed in the electrolyte solution 74 such that the fibers 104 are immersed in the electrolyte solution 74. A hollow tube 108 extends into the electrolyte solution 74 such that its first end 110 extends into the bottom opening 112 of the cylindrical tube 102. A second end (not shown) of the hollow tube 108 is attached to an oxygen source (not shown) such that the hollow tube 108 channels oxygen from the oxygen source (not shown) into the bottom opening 112 of the cylindrical tube 102. The oxygen, upon being released into the bottom opening 112 of the cylindrical tube 102 bubbles up through the electrolyte solution 74 past the fibers 104, such that the oxygen molecules make intermittent contact with the fibers 104.

The second electrode can also be in any form and comprise any material known in the art sufficient to ionize oxygen in an electrolyte solution.

The second electrode 100 is connected to the first electrode 78 via an electron conductor 114. As oxygen is pumped into the second electrode 100, electrons 116 travel via the electron conductor 114 to the second electrode 100 where they ionize the oxygen molecules in contact with the second electrode 100 according to the following formula: O2+2H2O+4e− [symbol] 4OH−. The OH− ions migrate through the electrolyte to combine with the elemental sulfur in the first electrode 78 according to the following reaction S+2OH−− [symbol] SO2+H2+2e−. The electrons 116 produced via this reaction travel again through the electron conductor 114. A resistor 120 is located within path of the electron conductor 114 on which the electrons 116 do work before returning to the second electrode 100. When the sulfur in the first electrode has been reacted, the first electrode can be replaced. It is also important to note that sulfur in a solid, liquid or gaseous state could be used in conjunction with this electrodes as well as various sulfur compounds.

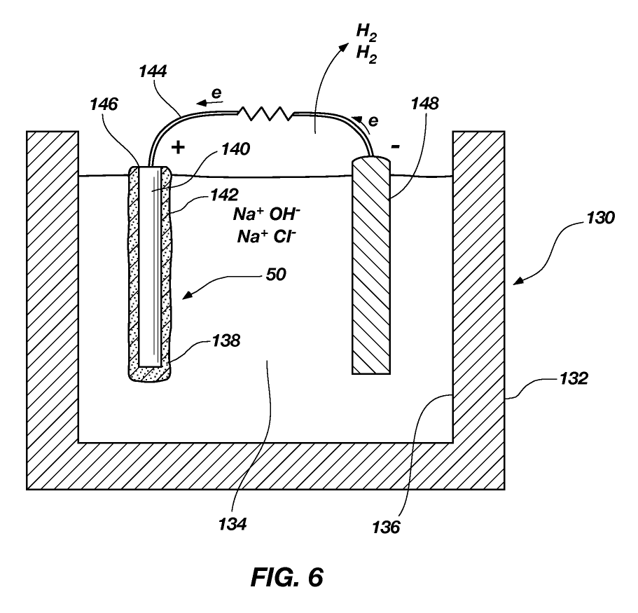

FIG. 6 is an illustration of an apparatus that utilizes sulfur as a consumable fuel in an electrochemical reaction to produce electricity and hydrogen. As depicted in FIG. 6, the electrochemical cell 130 comprises a container 132 capable of holding an electrolyte solution 134. This container 132 can be constructed of glass, plastic, fiberglass, rubber, or any other material that will generally not react with the electrolyte solution 134. The container 132 may also be constructed initially of one or more materials that will generally react with the electrolyte solution 134 so long as the inner surface 136 of the container 132 is lined with a non reactive material. The electrolyte solution 134 can contain be of any ph between 0 and 14. In the embodiment depicted in FIG. 6, the electrolyte solution 134 comprises a combination of Na+ OH− and Na+ Cl− dissolved in H2O. Immersed in the electrolyte solution 134 is a first electrode 138. This first electrode 138 is comprised of sulfur in combination with one or more other elements or compounds capable of conducting electricity. In this embodiment, the first electrode 138 comprises a copper core 140 having an outer coating 142 comprising a mixture of sulfur and powdered graphite. However, the core 140 can also be zinc, steel, lead, aluminum or any other metal, metal alloy or any other material capable of conducting electricity. An electron conductor 144 material extends from the top of the first electrode 146. While the sulfur in this embodiment is mixed with powdered graphite, the sulfur can be mixed with any material capable of conducting electricity. The apparatus 130 has a second electrode 148 immersed in the electrolyte solution 134 and in electrical contact with the first electrode 146 via the electron conductor 144. In this embodiment, the second electrode 148 is comprised of aluminum. However, the second electrode 148 can also be comprised of iron, steel, zinc, or any other electron conducting material capable of being oxidized by sulfur. It is also important to note that the electrolyte 134 can have any ph between 0 and 14.

Without being bound to any single theory, it appears that the reaction at the first electrode involves the ionization of sulfur in the presence of the electrolyte to form one or more forms of Sulfur Hydroxide ions or one or more hydroxide ions containing Sulfur or copper. These ions then react to oxidize the aluminum to form one or more of the Sulfate class of compounds in which one or more sulfur atoms or combination of sulfur and copper atoms are bonded to one or more aluminum atoms. Generally, however, it appears that the principal reaction products are aluminum sulfate, electrical energy and hydrogen. When the sulfur in the first electrode has been reacted, the first electrode can be replace.

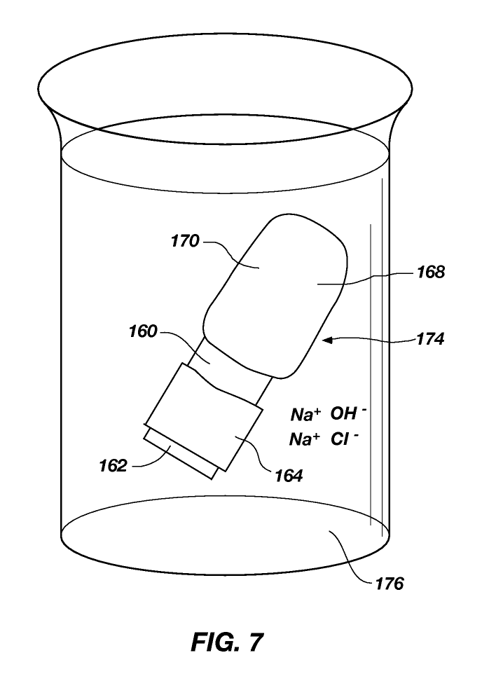

An alternative embodiment of this invention is depicted in FIG. 7. In this embodiment, a copper core 160 has a first end 162 that is coated with aluminum 164. A second end 168, is coated with sulfur mixed with powdered graphite 170. The entire electrode 174 is immersed in an electrolyte solution 176 comprising NaCl and NaOH dissolved in H20. The resulting oxidation/reduction reaction of the sulfur and aluminum produces hydrogen gas which bubbles out of the electrolyte solution. While in this embodiment, the electrode 174 comprises a copper core 160, the core 160 can be comprised of aluminum, iron, steel, zinc or any other metal, alloy or other material capable of conducting electricity. In addition, while the core 160 in this embodiment is coated in part with aluminum, the core 160 can also be coated with zinc, iron, steel or any other metal, alloy or other electricity conducting material capable of being oxidized by sulfur. Finally, while the sulfur in this embodiment is mixed with powdered graphite, the sulfur can be mixed with any material capable of conducting electricity.

The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An electrochemical cell wherein sulfur is consumed as a fuel.

2. The electrochemical cell of claim 1 further comprising at least one electrode comprising elemental sulfur.

3. The electrochemical cell of claim 2 wherein said at least one electrode further comprises conducting material.

4. The electrochemical cell of claim 3 wherein said conducting material comprises graphite.

5. The electrochemical cell of claim 1 further comprising:
a first electrode for ionizing oxygen; and
a second electrode comprising elemental sulfur.

6. The electrochemical cell of claim 5 wherein said second electrode further comprises conducting material.

7. The electrochemical cell of claim 6 wherein said conducting material comprises graphite.

8. The electrochemical cell of claim 1 further comprising:
a first electrode capable of being oxidized by sulfur; and
a second electrode comprising elemental sulfur.

9. The electrochemical cell of claim 8 wherein the said first electrode comprises aluminum.

10. An electrochemical cell electrode comprising sulfur.

11. The electrode of claim 10 wherein said electrode further comprises conducting material.

12. The electrode of claim 11 wherein said conducting material comprises graphite.

13. A method for using sulfur as a consumable fuel comprising:
an electrochemical cell comprising;
a first electrode wherein oxygen is ionized; and
a second electrode wherein elemental sulfur is oxidized to produce an electric current.

14. The method of claim 13 wherein said first electrode further comprises conducting material.

15. The method of claim 14 wherein said conducting material comprises graphite.

16. A method for using sulfur as a consumable fuel comprising:
an electrochemical cell comprising;
a first electrode comprising sulfur; and
a second electrode capable of being oxidized by sulfur.

17. The method of claim 16 wherein said first electrode further comprises conducting material.

18. The method of claim 17 wherein said conducting material comprises graphite.

19. The method of claim 18 wherein said second electrode comprises aluminum.
